(19) United States
(12) Patent Application Publication
(10) Pub. No.: US 2022/0113117 A1
(43) Pub. Date: Apr. 14, 2022

(54) RETICLE FOR MULTI-ROLE VIEWING OPTIC

(71) Applicant: Sheltered Wings, Inc. d/b/a Vortex Optics, Barneveld, WI (US)

(72) Inventors: David Hamilton, Barneveld, WI (US); Joe Heltemes, Barneveld, WI (US); Scott Parks, Barneveld, WI (US); Rick Campbell, Barneveld, WI (US)

(21) Appl. No.: 17/325,749

(22) Filed: May 20, 2021

Related U.S. Application Data
(60) Provisional application No. 63/028,084, filed on May 21, 2020.

(51) Int. Cl. F41G 1/38; G02B 27/34; F41G 1/473; F41G 3/08

(52) U.S. Cl. CPC F41G 1/38; F41G 3/08; F41G 1/473; G02B 27/34

(57) ABSTRACT

The disclosure relates to target acquisition and related devices, and more particularly to viewing optics and associated equipment used to achieve shooting accuracy at, for example, close ranges, medium ranges and extreme ranges at stationary and moving targets.

### CROSS REFERENCE TO RELATED APPLICATIONS

This application is a non-provisional application of and claims priority to U.S. Provisional Patent Application No. 63/028,084 filed May 21, 2020, which is incorporated herein by reference in its entirety.

### FIELD

The disclosure relates to target acquisition and related devices, and more particularly to viewing optics and associated equipment used to achieve shooting accuracy at, for example, close ranges, medium ranges and extreme ranges at stationary and moving targets.

### BACKGROUND

Users of firearms, whether they are police officers, soldiers, Olympic shooters, sportswomen and sportsmen, hunters, or weekend enthusiasts have one common goal: hitting their target accurately and consistently. When switching back and forth between close targets and distance targets, accuracy depends largely on the ability to change focus reliably.

Current reticle designs for viewing optics are generally designed for either close/medium ranges or long ranges. Current reticle designs for viewing optics for close/medium ranges are either overly complex to the average shooter, or do not take advantage of the higher magnification provided by advancing optical design technology. Other reticle designs attempting to accommodate different shooting ranges either provide too much detail resulting in an overwhelming and crowded view or oversimplified to the point that commonly useful tools are not available. For example, some existing reticles provide a number of features such as minute-of-angle scaling both to the right and left of a center dot and above and below, which assume a shooter has the training and time to utilize these features. These features can take up a significant space on a reticle, resulting in an obscured central aiming portion at low magnification and a crowded view at high magnification. On the other hand, some existing reticles provide too little information, such as omitting scale indicators or limiting the extent/range of aiming tools which take wind, drop and movement into account.

Accordingly, the need exists for a target acquisition device having a reticle which includes, for example, a balance of utility at low magnification and high magnification and/or a reticle which minimizes the business in views at low magnification and high magnification while still providing tools useful to most shooters.

### SUMMARY

In one embodiment, the disclosure provides a reticle. In an embodiment, the reticle comprises a) a crosshair feature comprising at least three non-intersecting crosshairs extending radially toward an optical center of the reticle and which divide the reticle into at least three quadrants; b) a center dot positioned at the optical center of the reticle and comprising a center portion partially surrounded by a discontinuous ring; and c) at least one of i) a first range estimation feature, ii) a drop point-of-impact estimation feature, iii) a wind point-of-impact estimation feature, and iv) a moving target point-of-impact estimation feature.

In yet another embodiment, the reticle comprises a) a crosshair feature comprising a right crosshair extending radially from the circumference toward the optical center at approximately 90°, a left crosshair extending radially from the circumference toward the optical center at approximately 270°, and a bottom crosshair extending radially from the circumference toward the optical center at approximately 180°, wherein in the right, left and bottom crosshairs do not intersect the optical center and divide the reticle into at least an upper quadrant, a lower left quadrant, and a lower right quadrant; b) a center dot positioned at the optical center of the reticle and comprising a center portion partially surrounded by a discontinuous ring; c) a plurality of markings extending linearly between the right and left crosshair at calculated intervals forming a moving target point-of-impact estimation feature; d) a drop point-of-impact estimation feature comprising a primary vertical axis extending downward from but not intersecting the center dot, a plurality of cross-markings perpendicularly intersecting the primary vertical axis, and at least one indicium associated with at least one of the plurality of cross-markings; e) a wind point-of-impact estimation feature comprising at least four pairs of markings, wherein one pair of markings extends linearly from each end of at least two of the horizontal cross-markings of the drop point-of-impact estimation feature; f) a range estimation feature in the upper quadrant, the range estimation feature comprising a primary vertical axis intersected at calculated interval by a plurality of perpendicular cross-markings having a calculated lengths and separated by calculated distances, wherein the calculated lengths and calculated distances are based on a target having a target area with an approximate width of 18 inches and an approximate height of 40 inches.

In yet another embodiment, the reticle comprises a) a crosshair feature comprising a right crosshair extending radially from the circumference toward the optical center at approximately 90° and terminating at a calculated interval from center such that it is to be considered a moving target point-of-impact estimation feature, a left crosshair extending radially from the circumference toward the optical center at approximately 270° and terminating at a calculated interval from center such that it is to be considered a moving target point-of-impact estimation feature, and a bottom crosshair extending radially from the circumference toward the optical center at approximately 180°, wherein in the right, left and bottom crosshairs do not intersect the optical center and divide the reticle into at least an upper quadrant, a lower left quadrant, and a lower right quadrant; b) a center dot positioned at the optical center of the reticle and comprising a center portion partially surrounded by a discontinuous ring; c) two, or more, markings extending linearly at calculated intervals forming a moving target point-of-impact estimation feature that includes, but is not limited to, the left and the right crosshair; d) a drop point-of-impact estimation feature comprising a primary vertical axis extending downward from but not intersecting the center dot, a plurality of cross-markings perpendicularly intersecting the primary vertical axis, and at least one indicium associated with at least one of the plurality of cross-markings; e) a wind point-of-impact estimation feature comprising at least four pairs of markings, wherein one pair of markings extends linearly from each end of at least two of the horizontal cross-markings of the drop point-of-impact estimation feature; f) a range estimation feature in the upper quadrant, the range estimation feature comprising a primary vertical axis intersected at calculated interval by a plurality of perpendicular cross-markings having a calculated lengths and separated by calculated distances, wherein the calculated lengths and calculated distances are based on a target having a target area with an approximate width of 18 inches and an approximate height of 40 inches.

In a further embodiment, the disclosure provides a viewing optic comprising a reticle as provided herein.

In another embodiment, the disclosure provides a viewing optic comprising a housing, an objective lens assembly mounted within a first end of the housing, an ocular lens assembly mounted within a second end of the housing, one or more optical components mounted within the housing between the objective lens assembly and the ocular lens assembly, and a reticle mounted within the housing between the objective lens assembly and one or more optical components, wherein the reticle is as provided herein.

Other embodiments will be evident from a consideration of the drawings taken together with the detailed description provided below.

### BRIEF DESCRIPTION OF THE DRAWINGS

FIG. 1 is a diagram showing the optical components of a viewing optic of the disclosure.

FIG. 2 is a partial side view of an example of a firearm showing a viewing optic mounted on the barrel.

FIGS. 3A and 3B represent frontal views of a reticle in accordance with non-limiting embodiments of the disclosure.

FIG. 4 illustrates a process of range estimation using the reticle of FIG. 3A in accordance with non-limiting embodiments of the disclosure. A standard competition target at 300 yards as estimated by angular measurement of target's 18 inch width. Center mass of target is acquired on ballistic solution reference and engaged and point of impact shown.

FIG. 5 illustrates a second process of range estimation using the reticle of FIG. 3A in accordance with non-limiting embodiments of the disclosure. Range estimated to be 500 yards by approximately 40 inches of height for average person's bottom of torso to top of head

FIG. 6 illustrates a third process of range estimation using the reticle of FIG. 3A in accordance with embodiments of the disclosure. Range estimated to be 400 yards for target that is known to be about 12 inches across.

FIG. 7 illustrates a process of using a cross-wind point-of-impact reference tool of the reticle of FIG. 3A in accordance with non-limiting embodiments of the disclosure. Range estimated to be 400 yards for target that is known to be about 12 inches across. Wind estimated to be blowing about 10 miles per hour from left to right. Center mass of target is acquired on ballistic solution reference and engaged and impact due to force of wind on projectile shown.

FIGS. 8A and 8B illustrates a process of using a point-of-impact for moving targets reference tool of the reticle of FIG. 3A in accordance with non-limiting embodiments of the disclosure. Target estimated to be moving 10 miles per hour from left to right and aligned to ballistic solution reference for 10 miles per hour mover in given direction. Impact due to time of flight of projectile shown.

FIG. 9 is a frontal view of the reticle of FIG. 3A at 1× magnification in accordance with non-limiting embodiments of the disclosure.

FIG. 10 illustrates simulated illumination of the frontal view of the reticle shown in FIG. 9 in accordance with non-limiting embodiments of the disclosure. Collective surface area of reflective surface creates a “red dot” style illusion of reticle at low magnification.

FIG. 11 is a frontal view of the reticle of FIG. 3A at 8× magnification in accordance with non-limiting embodiments of the disclosure.

### DETAILED DESCRIPTION

The apparatuses and methods disclosed herein will now be described more fully hereinafter with reference to the accompanying drawings, in which embodiments of the disclosure are shown. The apparatuses and methods disclosed herein may, however, be embodied in many different forms and should not be construed as limited to the embodiments set forth herein. Rather, these embodiments are provided so that the disclosure will be thorough and complete and will fully convey the scope of the invention to those skilled in the art.

It will be appreciated by those skilled in the art that the set of features and/or capabilities may be readily adapted within the context of a standalone viewing optic, such as a weapons sight, front-mount or rear-mount clip-on weapons sight, and other permutations of field deployed optical weapons sights. Further, it will be appreciated by those skilled in the art that various combinations of features and capabilities may be incorporated into add-on modules for retrofitting existing fixed or variable viewing optics of any variety.

The numerical ranges in this disclosure are approximate, and thus may include values outside of the range unless otherwise indicated. Numerical ranges include all values from and including the lower and the upper values (unless specifically stated otherwise), in increments of one unit, provided that there is a separation of at least two units between any lower value and any higher value. As an example, if a compositional, physical or other property, such as, for example, distance, speed, velocity, etc., is from 10 to 100, it is intended that all individual values, such as 10, 11, 12, etc., and sub ranges, such as 10 to 44, 55 to 70, 97 to 100, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, distances from a user of a device to a target.

Spatial terms, such as “beneath,” “below,” “lower,” “above,” “upper,” and the like, may be used herein for ease of description to describe one element's or feature's relationship to another element(s) or feature(s) as illustrated in the figures. It will be understood that the spatially relative terms are intended to encompass different orientations of device in use or operation in addition to the orientation depicted in the figures. For example, if the device is turned over, elements described as “below” or “beneath” other elements or features would then be orientated “above” the other elements or features. Thus, the exemplary term “below” can encompass both an orientation of above and below. The device may be otherwise oriented (rotated 90° or at other orientations) and the spatially relative descriptors used herein interpreted accordingly.

As used herein, the term “and/or” includes any and all combinations of one or more of the associated listed terms. For example, when used in a phrase such as “A and/or B,” the phrase “and/or” is intended to include both A and B; A or B; A (alone); and B (alone). Likewise, the term “and/or” as used in a phrase such as “A, B and/or C” is intended to encompass each of the following embodiments: A, B and C; A, B, or C; A or C; A or B; B or C; A and C; A and B; B and C; A (alone); B (alone); and C (alone).

It will be understood that when an element or layer is referred to as being “on,” “connected to,” or “coupled to” another element or layer, it can be directly on, connected to or coupled to the other element or layer. Alternatively, intervening elements or layers may be present. In contrast, when an element or layer is referred to as being “directly on,” “directly connected to,” or “directly coupled to” another element or layer, there are no intervening elements or layers present.

The disclosure relates to target acquisition and related devices, and more particularly to viewing optics and associated equipment used to achieve shooting accuracy at, for example, close ranges, medium ranges and extreme ranges at stationary and moving targets. Certain preferred and illustrative embodiments of the invention are described below. The present invention is not limited to these embodiments.

As used herein, “ballistics” is a way to precisely calculate the trajectory of a bullet based on a host of factors.

As used herein, the term “firearm” refers to any device that propels an object or projectile, for example, in a controllable flat fire, line of sight, or line of departure, for example, hand-guns, pistols, rifles, shotgun slug guns, muzzleloader rifles, single shot rifles, semi-automatic rifles and fully automatic rifles of any caliber direction through any media. As used herein, the term “firearm” also refers to a remote, servo-controlled firearm wherein the firearm has auto-sensing of both position and directional barrel orientation. The shooter is able to position the firearm in one location, and move to a second location for target image acquisition and aiming. As used herein, the term “firearm” also refers to chain guns, belt-feed guns, machine guns, and Gattling guns. As used herein, the term firearm also refers to high elevation, and over-the-horizon, projectile propulsion devices, for example, artillery, mortars, canons, tank canons or rail guns of any caliber.

As used herein, a “reticle,” in one embodiment, is a crosshair aiming point for a bullet. In another embodiment, a “reticle” is an aiming pattern for your bullet.

As used herein, “trajectory” is a bullet flight path over distance that is affected by gravity, air density, bullet shape, bullet weight, muzzle velocity, barrel twist direction, barrel twist rate, true bearing of flight path, vertical angle of muzzle, wind, and a number of other factors.

As used herein, the term “viewing optic” refers to an apparatus or assembly used by a user, a shooter or a spotter to select, identify and/or monitor a target. A viewing optic may rely on visual observation of the target or, for example, on infrared (IR), ultraviolet (UV), radar, thermal, microwave, magnetic imaging, radiation including X-ray, gamma ray, isotope and particle radiation, night vision, vibrational receptors including ultra-sound, sound pulse, sonar, seismic vibration, magnetic resonance, gravitational receptors, broadcast frequencies including radio wave, television and cellular receptors, or other image of the target. The image of the target presented to a user/shooter/spotter by a viewing optic may be unaltered, or it may be enhanced, for example, by magnification, amplification, subtraction, superimposition, filtration, stabilization, template matching, or other means. The target selected, identified and/or monitored by a viewing optic may be within the line of sight of the shooter or tangential to the sight of the shooter. In other embodiments, the shooter's line of sight may be obstructed while the viewing optic presents a focused image of the target. The image of the target acquired by the viewing optic may, for example, be analog or digital, and shared, stored, archived or transmitted within a network of one or more shooters and spotters by, for example, video, physical cable or wire, IR, radio wave, cellular connections, laser pulse, optical 802.1 lb or other wireless transmission using, for example, protocols such as html. SML, SOAP, X.25, SNA, etc., Bluetooth™, Serial, USB or other suitable image distribution method. The term “viewing optic” is used interchangeably with “optic sight.”

As used herein, the term “outward scene” refers to a real world scene, including but not limited to a target.

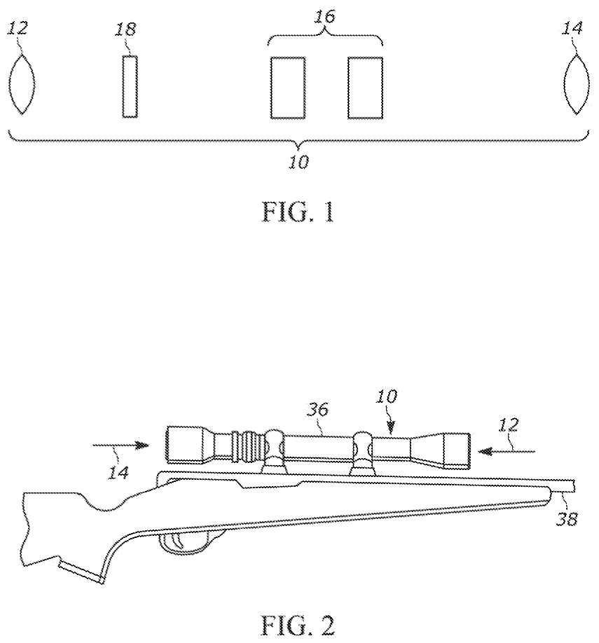

As exemplified in FIGS. 1 and 2, a viewing optic 10 (also referred to herein as a “scope”) includes a housing 36 that can be mounted in fixed relationship with a gun barrel 38. Housing 36 is preferably constructed from steel or aluminum, but can be constructed from virtually any durable, substantially rigid material that is useful for constructing optical equipment. Mounted in housing 36 at one end is an objective lens or lens assembly 12. Mounted in housing 38 at the opposite end is an ocular lens or lens assembly 14.

As used herein, the term “lens” refers to an object by means of which light rays, thermal, sonar, infrared, ultraviolet, microwave or radiation of other wavelength is focused or otherwise projected to form an image. It is well known in the art to make lenses from either a single piece of glass or other optical material (such as transparent plastic) which has been conventionally ground and polished to focus light, or from two or more pieces of such material mounted together, for example, with optically transparent adhesive and the like to focus light. Accordingly, the term “lens” as used herein is intended to cover a lens constructed from a single piece of optical glass or other material, or multiple pieces of optical glass or other material (for example, an achromatic lens), or from more than one piece mounted together to focus light, or from other material capable of focusing light. Any lens technology now known or later developed finds use with the present invention. For example, any lens based on digital, hydrostatic, ionic, electronic, magnetic energy fields, component, composite, plasma, adoptive lens, or other related technologies may be used. Additionally, moveable or adjustable lenses may be used. As will be understood by one having skill in the art, when the scope 10 is mounted to, for example, a gun, rifle or weapon 38, the objective lens (that is, the lens furthest from the shooter's eye) 12 faces the target, and the ocular lens (that is, the lens closest to the shooter's eye) 14 faces the shooter's eye.

Other optical components that may be included in housing 36 include variable power optical components 16 for a variable power scope. Such components 16 typically include magnifiers and erectors. Such a variable power scope permits the user to select a desired power within a predetermined range of powers. For example, with a 3-12×50 scope, the user can select a lower power (e.g., 3×50) or a high power (e.g., 12×50) or any power along the continuous spectrum.

Finally, a reticle assists the shooter in hitting the target. The reticle is typically (but not necessarily) constructed using optical material, such as optical glass or plastic, or similar transparent material, and takes the form of a disc or wafer with substantially parallel sides. The reticle may, for example, be constructed from wire, spider web, nano-wires, an etching, or may be analog or digitally printed, or may be projected (for example, on a surface) by, for example, a mirror, video, holographic projection, or other suitable means on one or more wafers of material. In one embodiment, illuminated reticles are etched, with the etching filled in with a reflective material, for example, titanium oxide, that illuminates when a light or diode powered by, for example, a battery, chemical or photovoltaic source, is rheostatically switched on compensating for increasing (+) or decreasing (−) light intensity. In a further embodiment, the illuminated reticle is composed of two or more wafers, each with a different image, for example, one image for daylight viewing (that is, a primary reticle), and one image for night viewing (that is, a secondary reticle). In a still further embodiment, if the shooter finds it undesirable to illuminate an entire reticle, since it might compromise optical night vision, the secondary reticle illuminates a reduced number of dots or lines. In yet another embodiment, the illuminated primary and secondary reticles are provided in any color. In a preferred embodiment, the illuminated reticle of the shooter's aiming device is identical to one or more spotter target acquisition devices such that the spotting device independently illuminates one or both of the reticles.

In a particularly preferred embodiment, illuminated reticles are used in, for example, low light or no light environments using rheostat-equipped, stereoscopic adaptive binoculars. With one eye, the shooter looks through a target acquisition device equipped with an aiming reticle of the present invention. With the opposite eye, the shooter observes the target using a night vision device, for example, the PVS 14 device. When the reticle and night vision device of the binocular are rheostatically illuminated, and the binocular images are properly aligned, the reticle of the target acquisition device is superimposed within the shooter's field of vision upon the shooter's image of the target, such that accurate shot placement can be made at any range in low light or no light surroundings.

In a fixed power scope, the reticle is mounted anywhere between the ocular lens 14 and the objective lens 12 of FIG. 1. In a variable power scope, the reticle is mounted between the objective lens 12 and the optical components 16. In this position, the apparent size of the reticle when viewed through the ocular lens will vary with the power. The present reticle may be mounted in a variable power target acquisition device, for example a variable power viewing optic. The variable power scope may magnify over any suitable range and objective lens diameter, for example a 3-12×50, a 4-16×50, a 1.8-10×40, 3.2-17×44, 4-22×58 viewing optic, etc.

When the reticle 18 is mounted between the objective lens and the variable power optical components 16, as in the embodiment shown, the markings on the reticle change size as magnification is increased. Thus, a unit of measure is consistent no matter the magnification.

As shown in the Figures, the reticle 18 is formed from a substantially flat disc or wafer 19 formed from substantially transparent optical glass or other material suitable for manufacturing optical lenses. Disc 19 has two, substantially parallel, sides. The markings, described in further detail herein, are provided on one side of said disc 19 using conventional methods such as, for example, etching, printing, engraved by machine or burned by laser, holographic technology, or applying hairs or wires of a known diameter. In a particular embodiment, etching is used.

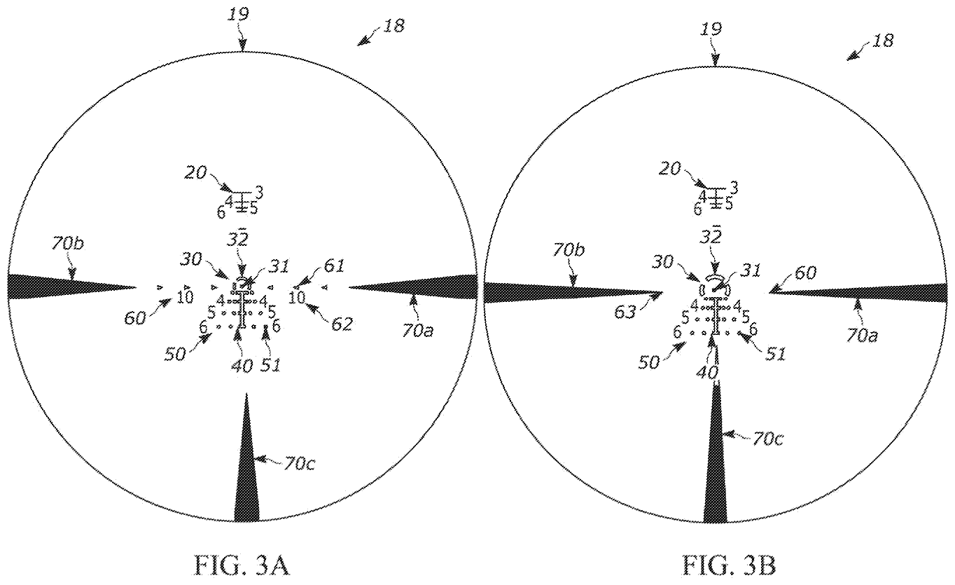

With reference to FIGS. 3A and 3B, the reticle 18 has six primary features: (i) a first range estimation feature 20, (ii) a center dot 30 at the optical center of the reticle 18, (iii) a drop point-of-impact estimation feature 40, (iv) a wind point-of-impact estimation feature 50, (v) a moving target point-of-impact estimation feature 60, and (vi) crosshair feature 70. In further embodiments, the reticle 18 may only include one, two, three, four or five of features (i)-(vi). In a particular embodiment, the reticle 18 includes at least a center dot 30, a crosshair feature 70, and at least one of a first range estimation feature 20, a drop point-of-impact estimation feature 40, a wind point-of-impact estimation feature 50, and a moving target point-of-impact estimation feature 60.

As shown in FIGS. 3A and 3B as representative embodiments, identifier 20 refers to the range estimation feature; object can be 18 inches in width and/or 40 inches in height. Identifier 30 refers to the illuminated center dot and broken circle to provide rapid target acquisition at close and medium ranges. Identifier 40 refers to ballistic solution point-of-impact reference based on 55-77 grain 5.56 mm round traveling from 2700 to 3000 feet per second. Identifier 50 refers to 5 and 10 mile per hour cross wind point-of-impact reference points at respective distances. Identifier 60 refers to point-of-impact references points for targets moving laterally relative to the shooter. Identifier 70 refers to thick left/right/lower/outside crosshairs to draw the user's eye to center point of aim.

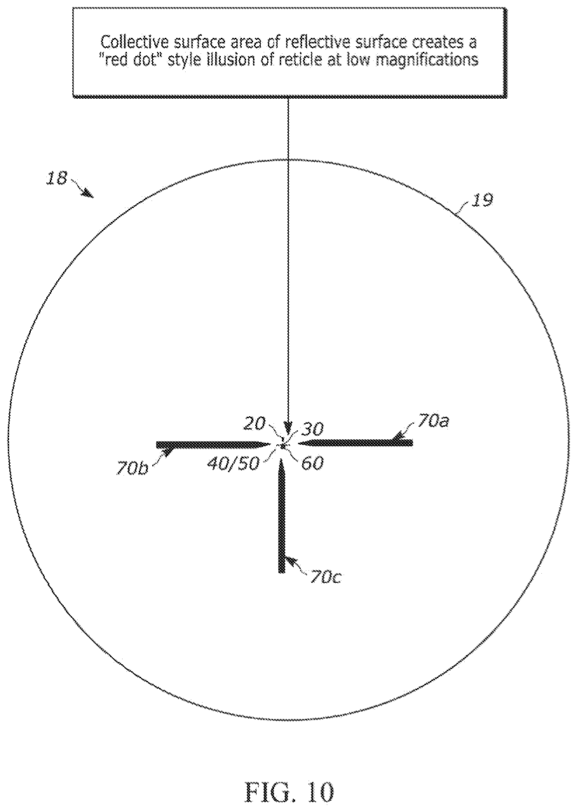

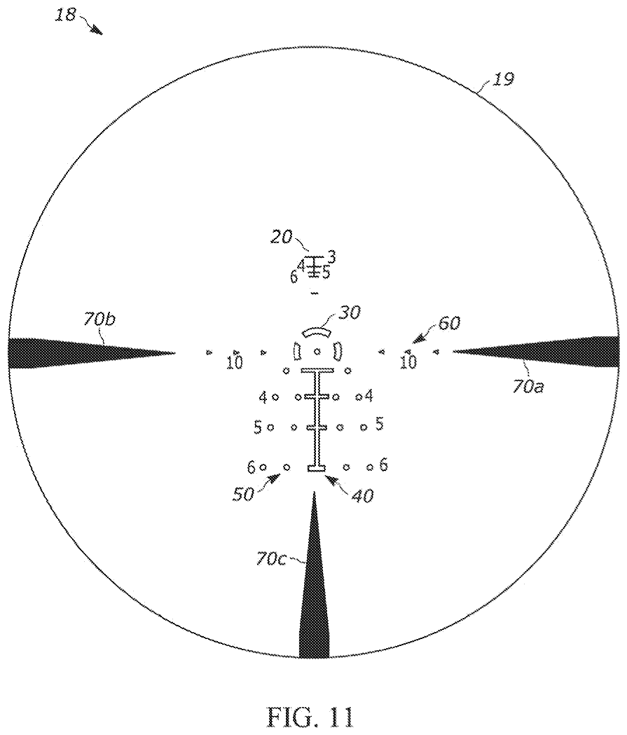

The crosshair feature 70 are thicker than the other markings and intended to draw a user's eye to the optical center of the reticle 18. That is, the crosshair feature includes at least three crosshairs that extend radially toward the optical center of the reticle, but do not intersect with the optical center of the reticle. The crosshair feature also divides the reticle into quadrants. The effect of the crosshair features 70 is further shown in FIGS. 9-11, with FIGS. 9 and 10 showing the reticle 18 at 1× magnification and FIG. 11 showing the reticle 18 at 8× magnification.

In the embodiment shown, only right horizontal 70a, left horizontal 70b and bottom vertical 70c crosshairs are provided. With reference to up being 0°, the right horizontal crosshair 70a is provided at approximately 90°, the left crosshair 70b at approximately 270°, and the bottom crosshair 70c at approximately 180°. However, in further embodiments, different numbers of crosshairs may be provided and/or be located at different positions around the reticle 18.

As shown perhaps best in FIGS. 9 and 10, the crosshairs 70a, 70b, 70c extending radially and linearly from a circumference of the reticle 18 toward the optical center of the reticle 18. The crosshairs 70a, 70b and 70c do not intersect with each other or the optical center to provide improved visibility of a target and the other features of the reticle. As a result, the reticle 18 can be viewed as being divided into upper and lower portions, with the lower portion being further divided into left and right quadrants and the center dot 30 at the center (i.e., where the crosshairs would intersect). Different quadrants will be provided depending on the position and number of crosshairs.

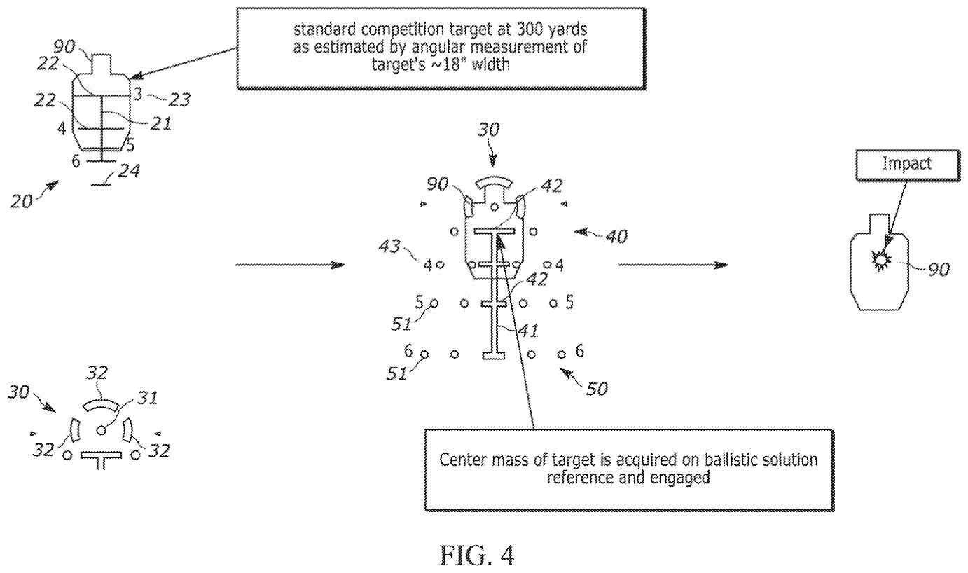

In the embodiment shown, and as shown in further detail in FIG. 4, the first range estimation feature 20 has a primary vertical axis 21, a plurality of horizontal cross-markings 22, each horizontal cross-marking 22 corresponding to a numerical indicium, and a base line 24 parallel with the horizontal cross-markings 22. The cross-markings 22 are perpendicular to and intersect the primary vertical axis 21 at specified calculated distances. The length of the primary vertical axis 21, length and position of the horizontal cross-markings 22 and position of the base line 24 are specifically calculated to provide range estimation of a target having a defined width and/or height. For example, in the specific embodiment shown, the length of the primary vertical axis 21 and length and position of the horizontal cross-markings 22 are specifically calculated to allow a user to estimate the range of an average human target having a torso width of approximately 18 inches. That is, the distance between cross-markings 22 and the length of the cross-markings 22 is particular to identifying a target having an average width of 18 inches. However, in further embodiments, the axis and markings 21, 22 may be specifically designed to a different proportion.

The base line 24 is set a calculated distance below the lowest cross-marking 22 and is used as a starting point in estimating the range of a target of known height. For example, in the embodiment shown, the distance between the base line 24 and the cross-markings 22 is specifically designed to estimate the range of a target having a torso height (e.g., from waist to shoulders) of 40 inches. However, in further embodiments, the cross-markings and base line 22, 24 may be specifically designed to a different proportion.

As shown in FIG. 4, the numerical indicia 23 associated with the horizontal cross-markings 22 range from 3 to 6. These numbers correspond to a range of the target when the target is properly aligned within the first range estimation feature 20, with the single digit representing its value as multiplied by 100 units, such as, for example, in the embodiment shown, 100 yards. It will be understood, however, that different scales, units and distances may be accounted for by adjusting the spacing of the horizontal cross-markings and/or assumed size of a target, with the indicia changing as necessary.

A numerical indicium 23 is provided next to a corresponding horizontal cross-marking 22, with the numerical indicia 23 alternating sides of the horizontal cross-markings to allow for larger font size and less crowding. For example, the first cross-marking is labeled 3 in the embodiment shown, with the 3 positioned to the right of the cross-marking, while the label for the second cross-marking (4) is provided on the left of the cross-marking. In other embodiments, indicia may be provided on the same side of the horizontal cross-markings. In still further embodiments, only even or only odd indicia may be provided, or indicia may be otherwise provided in association with every other cross-marking (or less than every cross-marking).

The first range estimation feature 20, as a whole, is provided a distance apart from the remaining elements of the reticle 18 in order to allow for range estimation separate from aiming and avoid cluttering a user's view when making a shot, such as shown in FIGS. 9-11. While in the embodiment shown the first range estimation feature 20 is provided above the remaining elements of the reticle, so that the primary vertical axis 21 is centered above the center dot 30, it will be appreciated that the first range estimation feature may be offset or otherwise positioned.

The center dot 30 is located at the optical center of the reticle 18 and includes a small center portion 31 surrounded in part by a broken circle 32, as shown in FIG. 3A and in further detail in FIG. 4, for example. In particularly, the center portion 31 is located at the optical center of the reticle 18, with the broken circle 32 positioned axially outward from the optical center. This two-part design of the center dot 30 acts to draw a user's eye to the center quickly to take aim, with the small center portion 31 small enough to make a precise shot, particularly at higher magnifications. The center portion's 31 small size would make it insufficient alone when the reticle is illuminated. However, a larger center portion 31 would obscure too much of a view at high magnification. The broken circle 32 is therefore provided to act as a visual reference and reflect light back to a user's eye when the reticle is illuminated without obscuring more view than is necessary. The increased surface area to reflect light is beneficial at low magnification as well, as it mimics a “red dot” style optic.

For example, FIG. 9 illustrates the reticle 18 at 1× magnification. The center dot 30 is small enough for precise aiming at low magnification and, as shown in FIG. 10, provides sufficient surface area to reflect light back at low magnification. In the particular embodiment shown in FIG. 10, both the center dot 30 and the main axis 41 drop point-of-impact estimation feature 40 are illuminated. However, in further embodiments, the center dot 30 alone may be illuminated or one or more portions of the wind point-of-impact estimation feature 50, a moving target point-of-impact estimation feature 60, and crosshair features 70 (or additional features of the drop point-of-impact estimation feature 40) may be illuminated.

In the embodiment shown, the broken circle 32 is made of three dashed portions which collectively and discontinuously encircle the center portion 31 from approximately 150°, or 160°, or 170° or 180° or 190° to 200°, or 210°, or 220°, or 240°. The final dimension of the broken circle 32, including how much the center portion 31 is surrounded and the number of portions of the broken circle 32, may be changed in order to accommodate different technologies and illumination means.

The drop point-of-impact estimation feature 40 is located immediately below the center dot 30. The drop point-of-impact estimation feature 40, as shown in further detail in FIG. 4, has a primary vertical axis 41 extending linearly downward from a calculated point below the center portion 31 of the center dot 30. A plurality of linear cross-markings 42 are perpendicular to and intersect the primary vertical axis 41 at calculated distances. That is, the location of each cross-marking 42 is specifically calculated to correspond to drop experienced by a pre-determined ballistic over a range as indicated by the respect. Each of the cross-markings 42 has a specifically calculated length, with each cross-marking 42 having a different calculated length. Each cross-marking 42 also has a pair of associated indicia 43. The length of each of the cross-markings 42 corresponds to the pre-determined width of a target at the range indicated by the indicia.

As shown in FIG. 4, the indicia 43 associated with the horizontal cross-markings 42 are numerical indicia ranging from 4 to 6. These numbers correspond to a range of the target, with the single digit representing its value as multiplied by 100 units, such as, for example, in the embodiment shown, 100 yards. It will be understood, however, that different scales, units and distances may be accounted for by adjusting the spacing of the horizontal cross-markings and/or assumed size of a target, with the indicia changing as necessary.

In the specific embodiment shown, the reticle 18 is designed for use in a scope securely fixed to a rifle with the reticle center dot 30 co-aligned with the average point-of-impact of projectiles from that rifle at 200 yards, that is, a rifle with a 200 yard zero. Hence, the first cross-marking 43 of the drop point-of-impact estimation feature 40, though lacking indicia for clarity of view, corresponds to drop at 300 yards. The drop estimations in the embodiment shown are based on a 55-77 grain 5.56 mm projectile traveling at 2700-3000 fps, but it will be appreciated that a reticle 18 can be designed and easily reconfigured for any ballistics. In the embodiment shown, the drop is approximated in MOA; however, it will be understood that other units of measure may be used.

While in the embodiment shown, drop-estimation is provided for a range from 200-600 yards, it will be appreciated that a lesser or wider range may be provided. However, it is known in the field that drop estimation at distances greater than 600 yards becomes increasingly unreliable for the specific ballistic used for estimation in this embodiment. Different ballistics will allow for (or require) different ranges of drop estimation. Further still, ranges may be marked at intervals other than 100 yards.

In the embodiment shown, the drop point-of-impact estimation feature 40 acts as a second range estimation feature. The cross-markings 41 each have a length corresponding to the width of a 12 inch wide target. In other words, when a 12 inch wide target is viewed along the cross-marking 41 with the indicium 4, and the target's width is approximately equal to the length of the cross-marking, the target is estimated to be at 400 yards. It will be appreciated that the length of the cross-markings 41 can be adjusted to account for targets of different widths and/or to estimate different ranges. In further embodiments, additional markings may be provided overlaying the drop point-of-impact estimation feature 40 to provide a separate second range estimation feature overlapping with the drop point-of-impact estimation feature 40.

Turning back to FIGS. 3A and 3B, the wind point-of-impact estimation feature 50 comprises a plurality of markings 51 at set and specifically calculated distances from the cross-markings 42 of the drop point-of-impact estimation feature 40. The result is a discontinuous extension of the cross-markings 42. In the present embodiments, markings are dots in order to reduce the amount of reticle covered by the markings. However, in further embodiments, the dots may be tics, hashmarks, lines, chevrons, or any other shape. In still further embodiments, the markings 51 may be connected by a continuous or discontinuous cross-marking 42.

In the specific embodiment shown, and with further reference to FIG. 4, each of the cross-markings 42 has four associated dots 51 (two on either side of the cross-marking 42) except for the first cross-marking 42, although any number of markings may be associated with a given cross-marking 42. The markings 51 closet to the respective cross-marking 42 in every pair represents the distance a projectile will travel crosswise due to a 5 mile per hour (mph) crosswind, and the further marking 51 in each pair a 10 mph wind. Because the first cross-marking 42 of the drop point-of-impact estimation feature 40 corresponds with a 300 yard range, only a 10 mph marking 51 is provided. A 5 mph crosswind will not have a noticeable impact at 300 yards.

As stated with respect to other features of this reticle 18, the wind point-of-impact feature 50 shown is specifically designed to show the effect of 5 mph and 10 mph crosswinds on a 55-77 grain 5.56 mm ballistic traveling at 2700-3000 fps. It will be appreciated, however, that a reticle 18 can be designed and easily reconfigured for any ballistics, use any unit of windspeed, and provide more or fewer wind point-of-impact indicators (e.g., markings 51) at a respective range.

In the embodiment shown by FIG. 3A, the moving target point-of-impact estimation feature 60 comprises a plurality of markings 61 extending linearly between the right 70a and left 70b crosshairs. The optical results is a discontinuous line connecting the right crosshair 70a and left crosshair 70b and passing through the center dot 30. In the embodiment shown by FIG. 3A, triangular markings are used to indicate direction of target travel while reducing the amount of reticle covered by the markings. However, in further embodiments, the markings may be dots, tics, hashmarks, lines, chevrons, or any other shape. In another embodiment shown by FIG. 3B, the moving target point-of-impact estimation feature 60 comprises the right 70a and left 70b crosshairs that extend radially inward to terminate at vertices 63 indicating direction of target travel. In still further embodiments, the markings 61 may be connected by a continuous or discontinuous indicator (e.g., line) with the markings 61 appearing as thickenings along the indicator.

In the embodiment shown by FIG. 3A, there are three markings 61 on either side of the center dot 30, with the middle marking in each set associated with an indicium 62. The markings represent the point of impact of a ballistic with respect to a target moving laterally relative to the shooter at 5 mph, 10 mph and 15 mph starting from the innermost markings. The middle markings in each set are labeled 10 (for 10 mph) for reference. In the embodiment shown by FIG. 3B, the right crosshair 70a and the left crosshair 70b extend radially inward to terminate at the vertex 63 of two sides of equal length that represent the point of impact of a ballistic with respect to a target moving laterally relative to the shooter at 10 mph.

As stated with respect to other features of this reticle 18, the moving target point-of-impact estimation feature 60 used in the embodiment shown by FIG. 3A is specifically designed to show the effect of a target's movement at 5 mph, 10 mph and 15 mph and assuming a 55-77 grain 5.56 mm ballistic traveling at 2700-3000 fps. The moving target point-of-impact estimation feature 60 used in the embodiment shown by FIG. 3B is specifically designed to show the effect of a target's movement at 10 mph assuming a 55-77 grain 5.56 mm ballistic traveling at 2700-3000 fps. It will be appreciated, however, that a reticle 18 can be designed and easily reconfigured for any ballistics, use any unit of target travel, provide more or fewer point-of-impact indicators (e.g., markings 61) at a respective speed, and provide additional markings at different ranges.

Turning to FIG. 4, a process of range estimation using the first range estimation feature 20 is illustrated. The target portion of a larger target 90 is centered along the primary vertical axis 21 and positioned vertically along that axis such that the width of the target portion approximately matches the length of one of the cross-markings 22. In the embodiment shown, the target portion has a width approximately equal to that of the first cross-marking having an indicium 3, or, 300 yards.

To aim to take a shot, the user then shifts the reticle view such that the target 90 is positioned in view of the center dot 30. Once the target portion of the target 90 is centered under the center dot 30, the user adjusts his or her aim such that the target portion is at the center of the first cross-marking 42 along the vertical axis 41 of the drop point-of-impact estimation feature 40. This will account for ballistic drop over the distance to the target. The resulting shot will impact the target portion as shown.

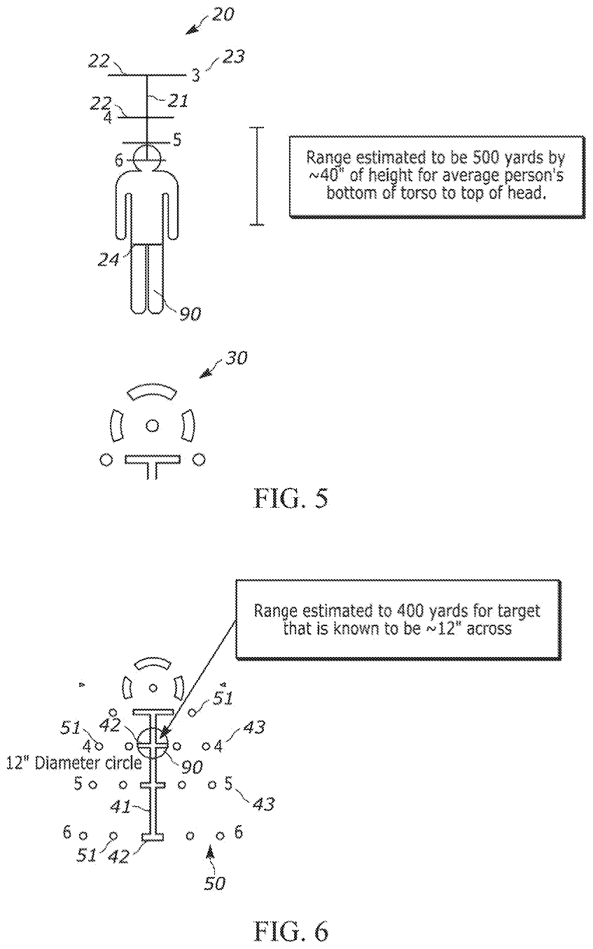

FIG. 5 shows a second process of range estimation using the first range estimation feature 20. Where the process illustrated in FIG. 4 used a target's width, the process shown in FIG. 5 uses a target's height. The target portion of a larger target 90 is centered along the primary vertical axis 21 and positioned vertically with the lowest portion of the target portion (e.g., center of mass) along base line 24. The height of the target 90 in the first range estimation feature 20 is representative of the target's range. That is, in the embodiment shown, the target 90 extends to the horizontal cross-marking 22 associated with the indicium 5, or 500 yards.

To aim to take a shot, the user positions the target portion of the target 90 at the center dot 30 and makes any appropriate adjustment for ballistic drop as described with respect to FIG. 4.

FIG. 6 illustrates a third process of range estimation using the drop point-of-impact estimation feature 40 to estimate range. A target 90 having a known width (i.e., 12 inches in the embodiment shown) is laterally centered along the vertical axis 41. The view is moved until the width of the target approximately matches the length of one of the cross-marks 42. In the embodiment shown in FIG. 6, the width of the target 90 matches the length of the cross-mark 42 associate with the indicium 4, or 400 yards. No further adjustments to account for drop are needed.

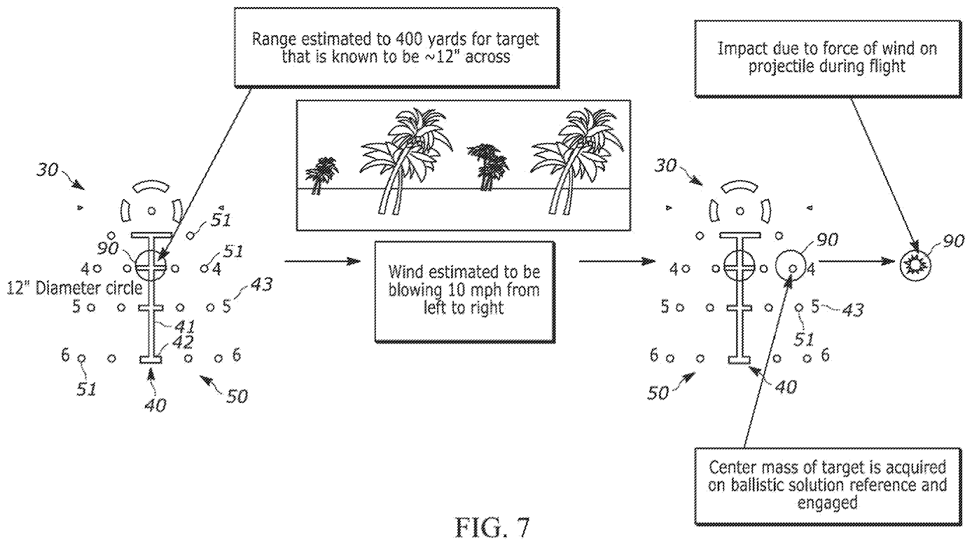

FIG. 7 illustrates a process of estimating the cross-wind point-of-impact using the wind point-of-impact feature 50. First the range of a target 90 is determined and appropriately positioned long the vertical axis 41 of the drop point-of-impact estimation feature 40. In the embodiment shown, the target is estimated at 400 yards. The user's aim is then adjusted to the left or right along the markings 51 depending on the wind speed. For example, in FIG. 7, the wind is estimated at 10 mph. The user therefore adjusts his or her aim so that the target 90 is positioned at the further of the two markings 51 on the right of the cross-marking 42.

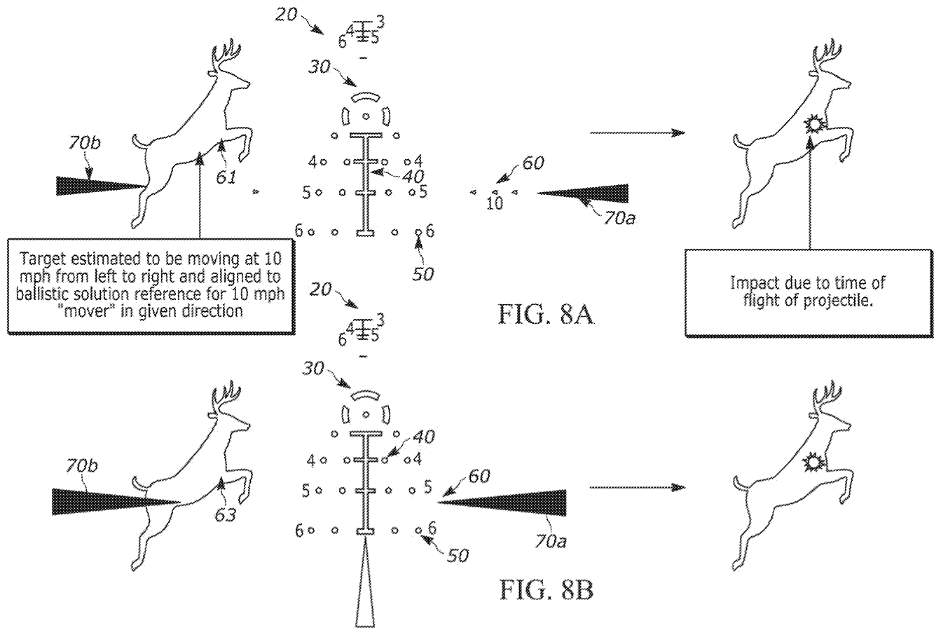

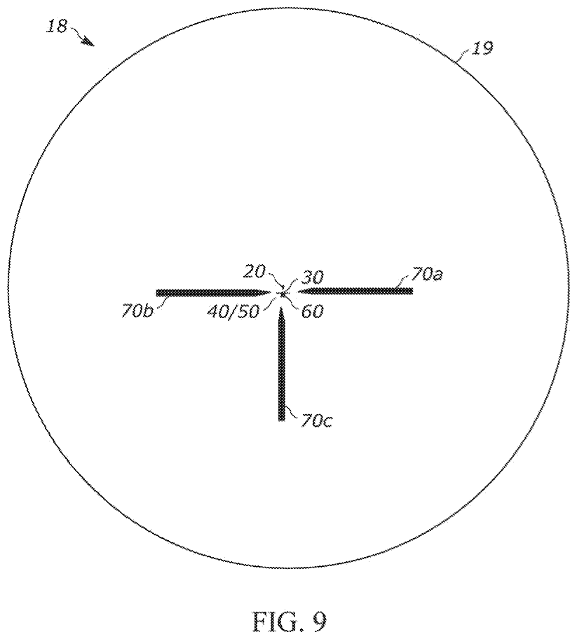

FIGS. 8A and 8B illustrate the process of using moving target point-of-impact estimation feature 60. Rather than centrally aligning a target at the vertical axis 41, the target 90 is positioned at one of the markings 61 or the vertices 63 of the right 70a or left 70b crosshair. In the embodiment shown by FIG. 8A, the target 90 is estimated to be moving from left to right at 10 mph. The target 90 is therefore centered at the marking 61 associated with the 10 indicium (10 mph) on the left of the center dot 30. In the embodiment shown by FIG. 8B, the target 90 is estimated to be moving from left to right at 10 mph. The target 90 is therefore centered at the vertex 63 of the left crosshair 70b.

All publications and patents mentioned in the above specification are herein incorporated by reference. Various modifications and variations of the described compositions and methods of the invention will be apparent to those skilled in the art without departing from the scope and spirit of the invention. One skilled in the art will recognize at once that it would be possible to construct the present invention from a variety of materials and in a variety of different ways. Although the invention has been described in connection with specific preferred embodiments, it should be understood that the invention should not be unduly limited to such specific embodiments. While the preferred embodiments have been described in detail, and shown in the accompanying drawings, it will be evident that various further modification are possible without departing from the scope of the invention as set forth in the appended claims. Indeed, various modifications of the described modes for carrying out the invention which are obvious to those skilled in marksmanship, computers or related fields are intended to be within the scope of the following claims.

What is claimed is:

1. A reticle comprising:
a) a crosshair feature comprising at least three non-intersecting crosshairs extending radially toward an optical center of the reticle and which divide the reticle into at least three quadrants;
b) a center dot positioned at the optical center of the reticle and comprising a center portion partially surrounded by a discontinuous ring; and
c) at least one of
i) a first range estimation feature,
ii) a drop point-of-impact estimation feature,
iii) a wind point-of-impact estimation feature, and
iv) a moving target point-of-impact estimation feature.

2. The reticle of claim 1, wherein the crosshair feature comprises at least a left crosshair and a right crosshair that bisect the reticle into an upper quadrant and a lower quadrant.

3. The reticle of claim 1, comprising the moving target point-of-impact feature.

4. The reticle of claim 3, wherein the moving target point-of-impact feature comprises two or more markings linearly arranged and intersecting with the center dot to form a discontinuous line through the center dot.

5. The reticle of claim 4, wherein the two or more markings form a discontinuous line between the left crosshair and the right crosshair.

6. The reticle of claim 4, wherein the markings have at least three sides, two sides of which are equal in length and intersect at a vertex such that the two sides point toward the center dot.

7. The reticle of claim 1 comprising the first range estimation feature.

8. The reticle of claim 7, wherein the first range estimation feature is a distance from the center dot in one of the at least three quadrants.

9. The reticle of claim 7, wherein the first range estimation feature comprises
a primary vertical axis,
a plurality of horizontal cross-markings intersecting the primary vertical axis, the horizontal cross-markings having differing lengths, and
at least one indicium associated with at least one of the plurality of horizontal cross-markings.

10. The reticle of claim 1, comprising the drop point-of-impact estimation feature.

11. The reticle of claim 10, wherein the drop point-of-impact estimation feature is adjacent the center dot.

12. The reticle of claim 10, wherein the drop point-of-impact estimation feature comprises
a primary vertical axis extending downward from the center dot,
a plurality of horizontal cross-markings intersecting the primary vertical axis, the horizontal cross-markings having differing lengths, and
at least one indicium associated with at least one of the plurality of horizontal cross-markings.

13. The reticle of claim 1, comprising the wind point-of-impact estimation feature.

14. The reticle of claim 13, comprising the wind point-of-impact estimation feature, wherein the wind point-of-impact estimation feature comprises at least four pairs of markings, wherein one pair of markings extends linearly from each end of at least two of the horizontal cross-markings of the drop point-of-impact estimation feature.

15. The reticle of claim 14, wherein the markings are dots.

16. A viewing optic comprising the reticle of claim 1.

17. A circular reticle having a circumference and an optical center, the reticle comprising:
a) a crosshair feature comprising a right crosshair extending radially from the circumference toward the optical center at approximately 90°, a left crosshair extending radially from the circumference toward the optical center at approximately 270°, and a bottom crosshair extending radially from the circumference toward the optical center at approximately 180°, wherein in the right, left and bottom crosshairs do not intersect the optical center and divide the reticle into at least an upper quadrant, a lower left quadrant, and a lower right quadrant;
b) a center dot positioned at the optical center of the reticle and comprising a center portion partially surrounded by a discontinuous ring;
c) two or more markings extending linearly between the right and left crosshair at calculated intervals forming a moving target point-of-impact estimation feature;
d) a drop point-of-impact estimation feature comprising
a primary vertical axis extending downward from but not intersecting the center dot,
a plurality of cross-markings perpendicularly intersecting the primary vertical axis, and
at least one indicium associated with at least one of the plurality of cross-markings;
e) a wind point-of-impact estimation feature comprising at least four pairs of markings, wherein one pair of markings extends linearly from each end of at least two of the horizontal cross-markings of the drop point-of-impact estimation feature;
f) a range estimation feature in the upper quadrant, the range estimation feature comprising a primary vertical axis intersected at calculated interval by a plurality of perpendicular cross-markings having a calculated lengths and separated by calculated distances, wherein the calculated lengths and calculated distances are based on a target having a target area with an approximate width of 18 inches and an approximate height of 40 inches.

18. A viewing optic comprising the reticle of claim 17.

19. A viewing optic comprising:
a housing;
an objective lens assembly mounted within a first end of the housing;
an ocular lens assembly mounted within a second end of the housing;
one or more optical components mounted within the housing between the objective lens assembly and ocular lens assembly; and
a reticle according to claim 17 mounted within the housing between the objective lens assembly and the one or more optical components.
